(19) United States
(12) Patent Application Publication
(10) Pub. No.: US 2016/0251805 A1
(43) Pub. Date: Sep. 1, 2016

(54) PAPER ESPECIALLY FOR PRINTING AN ELECTROCONDUCTIVE LAYER

(71) Applicant: ARJO WIGGINS FINE PAPERS LIMITED, Manchester (GB)

(72) Inventor: Gaël Depres, Chirens (FR)

(73) Assignee: ARJO WIGGINS FINE PAPERS LIMITED, Manchester (GB)

(21) Appl. No.: 15/030,789

(22) PCT Filed: Oct. 21, 2014
(86) PCT No.: PCT/EP2014/072575

§ 371 Date: Apr. 20, 2016

(30) Foreign Application Priority Data
Oct. 21, 2013 (FR) 1360249

(51) Int. Cl. D21H 19/60; B41M 5/50; B41M 5/52; D21H 19/40; D21H 19/38

(52) U.S. Cl. CPC D21H 19/60; D21H 19/40; D21H 19/385; B41M 5/5218; B41M 5/5254; B41M 5/508

(57) ABSTRACT

The invention relates to paper comprising a fibrous substrate having at least one face covered with at least one layer, said layer comprising or consisting of: 100 parts in dry weight of pigments; between 5 and 50 parts in dry weight of at least one binder resistant to exposure and temperatures of between 140° C. and 200° C. and having a glass transition temperature lower than 20° C., especially of at least one binder of the acrylic type having a glass transition temperature lower than or equal to 20° C., preferably lower than or equal to 10° C.; and between 0 and 15 parts in dry weight of a thickening agent, such as polyvinyl alcohol.

The present invention relates to a paper, intended in particular for printing an electroconductive layer, as well as to its production process.

Papermaking techniques which are known to the person skilled in the art may be employed in order to produce a paper in accordance with the invention. A known process consists of preparing a homogeneous pulp in a pulper by mixing cellulose fibres and water. The pulper allows stirring and shearing the fibres so as to separate them and isolate them with a view to forming a fibrous suspension.

The pulp then passes through a refiner. This comprises a stator and a rotor turning at high speed, equipped with teeth or radial serrations. The pulp moves between the rotor and the stator of the refiner in a manner such as to modify the structure of the wall of the fibres in order to introduce water into the interior of the fibres with a view to cutting the fibres and/or increasing fibril formation and, as a consequence, the potential for bonding between fibres.

The composition of the pulp may then be adjusted before being sent to the head box of a paper machine.

The head box can be used to uniformly distribute the pulp over a moving wire of a drainage table (in the case of a Fourdrinier machine), where it is drained through the mesh of the wire under gravity and by suction with the aid of suction boxes with a view to producing a sheet. A felt is generally applied to the sheet, opposite to the wire. At the outlet from the drainage table, the sheet still contains a large quantity of water.

During this step, the fibres are orientated mainly in the direction of displacement of the wire, termed the machine direction. The term “cross-machine direction” defines the direction perpendicular to the machine direction. Furthermore, the side of the sheet which is applied against the wire (wire side) generally has a greater roughness than the opposite side (felt side).

Paper machines known as twin wire paper machines also exist; they comprise two opposing wires applied to either side of the sheet. Water may be evacuated by suction through each of the wires.

Once the sheet of paper is formed, it passes through the press section of the paper machine in order to remove more water. To this end, the sheet passes between a series of cylinders compressing the sheet in order to extract water from it. During this step, the sheet of paper is also sandwiched between absorbent felts in the form of continuous belts, suction boxes enabling the water absorbed by the felts to be withdrawn upon completion of pressing of the sheet, before the felts are applied against the sheet once more.

The sheet then passes through a dryer composed of a series of cylinder heated with steam, on which the sheet is passed. The temperature of the rolls increases gradually, from upstream to downstream with respect to the direction of displacement of the sheet.

The wet section of the paper machine is defined as the set of elements of the machine (head box, drainage table) located upstream of the dryer.

Once the moisture content of the sheet has been substantially reduced, and is, for example, of the order of 5%, the sheet may undergo a surface sizing treatment by being passed through a size press. The size press is generally formed by two rolls disposed side by side in a manner such as to form a nip supplied with a sizing solution or bath with a specific composition. The sheet passes between the rolls in a manner such as to coat, for example, one or both of its opposed sides with the solution in order to form a layer.

The sheet then passes into a section known as the calender section in which it is again applied against one or more steam-heated rolls.

At the end of these various steps, the sheet is in the form of a continuous web comprising an inner zone or core forming a fibrous substrate or mat, at least one outer side or surface of which is covered with a layer or coating.

This sheet may optionally undergo finishing operations such as, for example, calendering or smoothing in order to improve the surface condition of the sheet before being wound, cut and packaged into reels, for example.

A paper intended for printing an electroconductive layer is particularly appropriate, but not exclusively so, for use in electronics applications such as in printed electronics.

Printed electronics consists of depositing an electroconductive layer onto a supple and flexible support, such as plastic film using known techniques, with a view to producing electronic components such as electronic chips, of the RFID type for example.

However, although plastic films (such as those made from PEN and from PET) have a low surface roughness which is particularly advantageous for printed electronics, these plastic films are not very thermally stable and are relatively expensive (the cost of these films being greater than or equal to approximately 4 euros/m²).

The Applicant's patent application WO 2013/104520 discloses a process for the production of a sheet comprising at least one electroconductive layer, this sheet comprising a paper substrate, at least one side of which is at least partially covered with a layer or with several superimposed layers including said electroconductive layer, the method comprising the steps consisting of:

a/ preparing or providing a multi-layer structure comprising at least, or constituted by, a plastic film, an anti-adhesive coating, and a base layer, the anti-adhesive coating being inserted between a side of the plastic film and the base layer,
b/ applying glue to a side of the substrate and/or the side of the multi-layer structure located on the opposite side to the plastic film, and applying said side of the substrate against said side of the multi-layer structure, so as to cross-laminate the multi-layer structure and the substrate,
c/ removing the plastic film and the anti-adhesive coating from the base layer, the process being characterised in that the base layer is covered with an electroconductive layer by means of an additional step consisting of:
d1/ depositing an electroconductive film on the base layer; or
d2/ printing the base layer with at least one ink having electrical properties, the base layer being a printable layer based on a binder in a ratio of more than 15% in dry weight with respect to the total dry matter weight of this layer, then optionally subjecting the printed sheet to an annealing heat treatment so as to form a layer of electroconductive ink.

In contrast to plastic films, papers and sheets based on paper are cheaper and also have the advantage of being capable of being recycled and having higher thermal stability. In addition, the use of sheets or papers for printed electronics allows very large printed surfaces to be produced, which are more difficult to obtain with plastic films. Furthermore, a sheet or a paper may be printed for an electronics application directly after it has been fabricated, i.e. the printing machine may be disposed directly after the paper fabrication machine using a continuous process (roll-to-roll process). In addition, it is easier to obtain a glossy white paper than a glossy white plastic film because the combination of the properties of whiteness and gloss is difficult to obtain with a plastic film, which is also more difficult to cover with a coating composition in an aqueous medium than a paper which has a hydrophilic nature.

Using the process described in patent application WO 2013/104520 allows producing a support wherein at least one side intended for printing is very smooth, with a roughness Ra in the range 1 to 30 nm, for example, which allows producing an electroconductive sheet by printing a layer of ink of very low thickness.

In cases where the inks used are relatively expensive, such as, for example, inks using silver nanoparticles, the fact that a very thin layer of ink is used allows substantially reducing the cost of producing an electroconductive sheet of this type.

However, the process cited above for producing a paper support is relatively complex and expensive. In cases where the inks used are cheaper or in cases where printing techniques are to be used which necessitate depositing a thicker layer, it is not necessary to use a support wherein the side intended for printing is that smooth. Indeed, in the case of a screen printing process, the layer of ink which is deposited is typically in the range 10 to 15 μm, this layer being in the range 1 to 3 μm in the case of a flexographic printing process. Thus, the inventors have determined the conditions in which a support comprising a side with a roughness Ra which is, for example, in the range 0.1 to 3 μm could be sufficient to produce high quality electroconductive sheets.

In addition, the highly pronounced smoothness provided by the aforementioned process means that the microporosity of the support is reduced, which has a negative influence on the adhesion of the ink to the surface of the support.

Thus, there is a need for the provision of a support, in particular formed from paper, which allows the use of the printing processes cited above with a view to forming an electroconductive sheet, and which can be economically produced.

Furthermore, after printing the layer of ink, the support thus coated with the layer of ink generally undergoes an annealing treatment which is carried out, for example, in a tunnel furnace or an oven and during which the paper and the layer of ink are subjected to a high temperature for a given period.

By way of example, patent application US 2009/0242019 describes the production of solar cells by depositing silane onto a flexible plastic support, annealing at a temperature in the range 250° C. to 400° C. allowing transforming the silane into polycrystalline silicon.

It should be noted that such a plastic support of this type has a relatively low heat resistance (with the exception of certain expensive plastics such as polyimide) compared with a paper support.

The use of a paper to produce an electroconductive product in the form of a sheet has the following disadvantages.

In the case in which an uncoated paper support is used onto which an electroconductive layer is produced by printing, it is observed that the conductivity of the tracks formed is relatively low. This can be explained by the very substantial roughness and porosity of the support, which cause a discontinuity in the electroconductive tracks. By way of example, the resistance of the conductive tracks printed by flexography with inks containing silver nanoparticles, with an annealing at 180° C. for 5 minutes onto a Bristol® type paper produced by Arjowiggins Creative Papers, is of the order of 3100 Ω/sq. It will be recalled that the higher this resistance, the lower is the conductivity of the conductive track.

In contrast, coated papers have pigment layers bonded with a synthetic latex, so that their surface porosity and roughness are lower. If these coated papers are printed with conductive inks, here again it is observed that the conductivity of the tracks obtained is mediocre, since a high temperature annealing cannot be carried out. In fact, coated papers of this type have poor dimensional stability (deformations or dimensional shrinkage during a high temperature annealing). By way of example, the resistance of the conductive tracks printed by flexography with inks containing silver nanoparticles with an annealing at 180° C. for 5 minutes on a Sensation® type paper produced by Arjowiggins Creative Papers is of the order of 1700 Ω/sq.

Besides, it has been observed that papers of this type turn yellow above 140° C.

Thus, there is a need for the provision of a paper which can act as a support for a layer of electroconductive ink deposited by printing in particular, and which is both inexpensive to produce, thermally resistant (low deformation or dimensional shrinkage at high temperature, low yellowing effect) and which allowing producing conductive tracks with good conductivity (in particular due to the relatively low porosity and/or low roughness of the surface of the paper which is to be printed).

The objective of the invention is, in particular, to provide a simple, effective and economical solution to this problem.

To this end, it provides a paper comprising a fibrous substrate comprising at least one side covered with at least one layer, said layer comprising or consisting of:
100 parts in dry weight of pigments,
5 to 50 parts in dry weight of one or more binders which are resistant to exposure to temperatures in the range 140° C. to 200° C. and having a glass transition temperature of less than 20° C., in particular of one or more acrylic binders the glass transition temperature of which is less than or equal to 20° C., preferably less than or equal to 10° C.,
0 to 15 parts in dry weight of a viscosifying agent such as polyvinyl alcohol, for example.

The layer may cover just one of the two sides of the substrate, or both sides of said substrate. The layer may cover the entirety of the side concerned or, in contrast, it may cover a limited zone, the surface area of which is smaller than the surface area of each side of the substrate.

In accordance with a particular embodiment of the invention, the fibrous substrate is completely or partially covered with a single layer and this layer is as defined above.

The use of binders which are heat resistant allows improving the heat resistance of the paper during an optional thermal annealing step, i.e. reducing the deformations or dimensional shrinkage as well as the effect of the yellowing produced during such an annealing step.

In a particular embodiment of the invention, the binder or the binders of the layer deposited onto the surface of the substrate and intended to be printed is an acrylic binder composed of acrylic ester and acrylonitrile with a glass transition temperature which is below 10° C. By way of example, the binder comprises or is constituted by Acronal LN579S sold by BASF.

Although the conventional wisdom is that a binder with a high glass transition temperature is more thermally resistant, the Applicant has surprisingly discovered that, in contrast, using a binder with a low glass transition temperature, in particular 20° C. or less, preferably 10° C. or less, allows considerably improving the thermal resistance of the paper, in particular in terms of deformation. This is illustrated in Examples 1 and 2 below.

Said layer may comprise 10 to 30 parts in dry weight of binder with a glass transition temperature of 20° C. or less, preferably 15 to 25 parts in dry weight, even more preferably 19 parts in dry weight. Preferably, an acrylic binder is used.

In a particular embodiment, said layer may comprise 0.05 to 15 parts in dry weight of viscosifying agent, more preferably 0.05 to 5 parts in dry weight, and even more preferably 0.05 to 4 parts in dry weight of such an agent.

In particular, said layer may comprise 5 to 10 parts in dry weight of polyvinyl alcohol used as a viscosifying agent, more preferably 8 parts in dry weight.

Examples of other viscosifying agents which may be cited include: polyvinyl alcohol (PVA), carboxymethylcellulose (CMC), hydroxymethylcellulose (HMC), an acrylic copolymer, a gelatine, an alginate, a soya protein, a galactomannan, a nanocellulose, a polysaccharide, a cross-linked polyacrylate, a polyvinylpyrrolidone, a hydrophobic ethoxylated urethane, and a hydrophobic emulsion which is expandable in an alkaline medium.

By way of example, said layer may comprise 0.05 to 1 part in dry weight of carboxymethyl cellulose, or of hydroxymethyl cellulose, used as a viscosifying agent.

The type of viscosifying agent is selected as a function of the coating process used. In general, the greater the quantity of viscosifying agent(s), the less the layer resists to high temperatures.

Preferably, the substrate comprises 70% to 90% in dry weight of short cellulose fibres, with a mean length comprised in the range 0.5 to 1.5 mm, such as wood fibres, in particular wood fibres obtained from eucalyptus.

The use of short fibres allows improving the thermal resistance of the paper as regards the deformation or dimensional shrinkage of the paper. Such an advantage is illustrated in Example 3.

Besides, it has been shown that the use of fibres comprising a small ratio of lignin such as wood fibres obtained from a bleached chemical pulp of eucalyptus, which are also short fibres, allows improving the thermal resistance of the paper (in particular of the substrate) in terms of yellowing in case of exposure to high temperatures. This is illustrated in Example 4.

Preferably, the substrate comprises 80% dry weight of short cellulose fibres, or more.

In a particular embodiment of the invention, the substrate is obtained from a fibrous pulp with a degree of refining of less than 50° SR, or less than 40° SR, preferably less than 35° SR.

Furthermore, the fibrous substrate comprises 10% to 30% of at least one mineral filler, for example calcium carbonate, kaolin or titanium dioxide.

Calcium carbonate, or any other mineral filler, allows reducing inter-fibre bonds and thus improving the dimensional stability.

Advantageously, the paper has a whiteness in the range 70 to 90, preferably in the range 75 to 85, in order to reduce the paper yellowing effect. This corresponds to a cream shade.

Whiteness is measured in accordance with ISO standard 2470.

Indeed, the Applicant has demonstrated that the difference in shade of the paper after an annealing step, compared with the same paper before annealing, is dependent on the colour of the paper before annealing. Thus, the whiter the paper before annealing, the more visible is the yellowing effect at high temperature. Thus, yellowing of a paper with a cream, vanilla or ivory colour is a lot less visible than in the case of a white paper. This is illustrated in Example 5.

Advantageously, the difference in shade ΔE of the paper, calculated from the CIE LAB coordinates of the paper, after an annealing at 200° C. for 5 minutes is less than 5, preferably less than 2, compared with said paper before annealing.

It should be noted that a difference in shade of 1 or less is not visible to the naked eye for a knowledgeable person. A difference in shade of 5 or less is relatively small. In this manner, it is ensured that the annealing step has little influence on the colour of the paper.

Besides, the layer covering the substrate of the paper in accordance with the invention does not comprise, or comprises very little, optical brighteners, i.e. fewer than 0.5 parts in dry weight per 100 parts in dry weight of pigments, preferably less than 0.1 parts in dry weight per 100 parts in dry weight of pigments.

Optical brighteners are used in the prior art in order to increase the whiteness of paper. While optical brighteners of this type can increase the whiteness at low temperatures, they are however destroyed when exposed to high temperatures, in particular during an annealing step. The resulting difference in shade at the end of such an annealing step is consequently higher as the quantity of optical brighteners is increased.

Furthermore, the layer covering at least one side may be printed over all or a portion of the area of said layer with a thickness of electroconductive ink of 0.1 to 20 μm, in particular 0.5 to 15 μm, and of 0.1 to 3 μm or 10 to 15 μm in a particular embodiment.

As was seen above, this printing may be carried out by screen printing, flexography or heliography.

An electroconductive ink is an ink comprising conductive elements such as nanoparticles and/or molecules, these elements endowing the paper printed with the ink (and optionally having undergone an annealing step) with an electrical conductivity.

The paper of the invention may be used for various types of application in the field of printed electronics; of which six stand forward:
printed circuits comprising conductive tracks, resistances, capacitances and transistors;
photovoltaic cells;
displays (electrochromic or LCD);
membrane keyboards; the sheet may then comprise a component or undergo a particular treatment to render it flameproof; the sheet may, for example, comprise flame retardants of the aluminium trihydroxide type, for example BACO FRF40® from Alcan Chemicals (values of 30% of BACO FRF40® in the bulk of the sheet may allow obtaining a fire rating of M1 or M2); it is also possible to add products, in the size press, of the phosphorus/ammonium salt type with ratios of 50% with respect to starch; other products may also be used, for example based on ammonium polyphosphate, antimony trioxide, ammonium sulphamate etc.;
OLEDs (organic electroluminescent diodes) are electroluminescent diodes the emitter material of which is an organic material; when a current passes through this material, it becomes a light source;
“switch” membranes (or membrane switches) can be used to make a temporary connection by contact; conductive ink is deposited on a flexible polyester or polycarbonate type support; a dome is formed and constitutes the active element of a button; under pressure, the dome is deformed and closes the circuit; this technology is used in mobile telephones, photographic cameras, control panels, toys etc.; and
RFID (Radio Frequency IDentification) labels, also known as intelligent labels or chip labels or tags or transponders, are equipments intended to receive a radio signal and return a different radio signal in response, containing information.

The invention thus concerns an object or product produced with an electroconductive printed paper in accordance with the invention, such as an object selected from the above list.

The invention also concerns a process for the production of a paper of the type cited above, characterized in that it comprises the steps consisting of:
forming a fibrous substrate with the aid of a fibrous pulp,
at least partially covering at least one surface of the fibrous substrate by coating with a layer comprising 100 parts in dry weight of pigments, 5 to 50 parts in dry weight of one or more binders which are resistant to exposure to temperatures comprised in the range 140° C. to 200° C. and having a glass transition temperature of less than 20° C., in particular of one or more acrylic binders, the glass transition temperature of which is less than or equal to 20° C., preferably less than or equal to 10° C., and 0 to 15 parts in dry weight of a viscosifying agent, preferably 0.05 to 15 parts of a viscosifying agent, for example polyvinyl alcohol.

As is generally the case in the papermaking field, the coating process refers to a process for the direct deposition of a layer (or coating) which is in an aqueous medium. Examples of processes for depositing a layer in an aqueous medium which may be cited are processes for deposition by a size press and by an air blade. In contrast to the process proposed in document WO 2013/104520, the coating processes used in the context of the invention do not involve transfer of a dry layer from an alternative support to the substrate.

Preferably, the degree of refining of the fibrous pulp is less than 50° SR, preferably less than 40° SR, more preferably of the order of 35° SR. It should be noted that for implementational reasons when carrying out the production process, it is in fact preferable for the degree of refining to be 20° SR or higher.

The Applicant has also demonstrated that the degree of refining of the fibrous pulp has an influence on the dimensional stability of the paper. Indeed, it has been observed that the lower the degree of refining, the less the paper will tend to deform. This phenomenon is illustrated in Example 6.

It should be noted that the measurement of the degree of refining, expressed in Schopper-Riegler degrees, is carried out in accordance with ISO standard 5267-1:1999. This degree of refining represents the quantity of water in centilitres drained through a cake of pulp and flowing via an overflow. This is a drainability index which can be used to measure the rate at which water can be extracted from a suspension of diluted pulp.

Preferably, said layer covering all or a portion of the fibrous substrate is applied by coating, using a size press of a paper machine for example, which means that the production costs for a paper of this type can be reduced.

The invention also concerns a process for the production of an electroconductive product, comprising the steps consisting of:
covering, by printing using an electroconductive ink, at least one zone of a support produced from a paper of the type cited above,
annealing the support and the ink in a manner such as to form an electroconductive layer or continuous track on the support.

In a particular embodiment, printing using electroconductive ink is carried out by flexography or screen printing.

The invention also concerns a paper as obtained by said process. The paper in accordance with the invention or as obtained by this process is capable of receiving and fixing, in a stable manner, an electroconductive ink because of its surface condition, exhibiting a surface porosity which is low but sufficient to allow the ink to penetrate the surface of the paper. Thus, the porosity of the surface of a paper in accordance with the invention has, in a Microcontour test such as that described in Example 8, an optical density value of more than 0 (at a wavelength between 380 and 780 nm) and in particular an optical density in the range 0.2 to 1 or in particular 0.2 to 0.8.

The annealing duration may be comprised in the range from less than one second to several minutes, the annealing temperature possibly being comprised in the range of 100° C. to 300° C., preferably of 180° C. to 220° C.

Furthermore, the layer of ink deposited onto the support by printing may be comprised in the range 0.5 to 15 μm, preferably in the range 1 to 10 μm.

In addition, the electroconductive ink may be deposited using a screen printing, flexographic or heliographic printing process.

Besides, the invention also concerns a paper comprising a fibrous substrate comprising a side covered with a layer onto which an electroconductive ink is printed, as obtained by means of steps consisting of:
forming a fibrous substrate with the aid of a fibrous pulp,
at least partially covering at least one surface of the fibrous substrate by coating with a layer comprising 100 parts in dry weight of pigments, 5 to 50 parts in dry weight of one or more binders which are resistant to an exposure to temperatures in the range 140° C. to 200° C. and having a glass transition temperature of less than 20° C., in particular of one or more acrylic binders, the glass transition temperature of which is less than or equal to 20° C., preferably less than or equal to 10° C., and 0.05 to 15 parts in dry weight of viscosifying agent;
covering at least one zone of the layer by printing using an electroconductive ink;
annealing the coated substrate and the ink in a manner such as to form an electroconductive layer or continuous track on the support.

The invention will now be illustrated by, and other details, characteristics and advantages of the invention will become apparent from, the following description which includes implementary examples of the invention, made with reference to the figures in which:

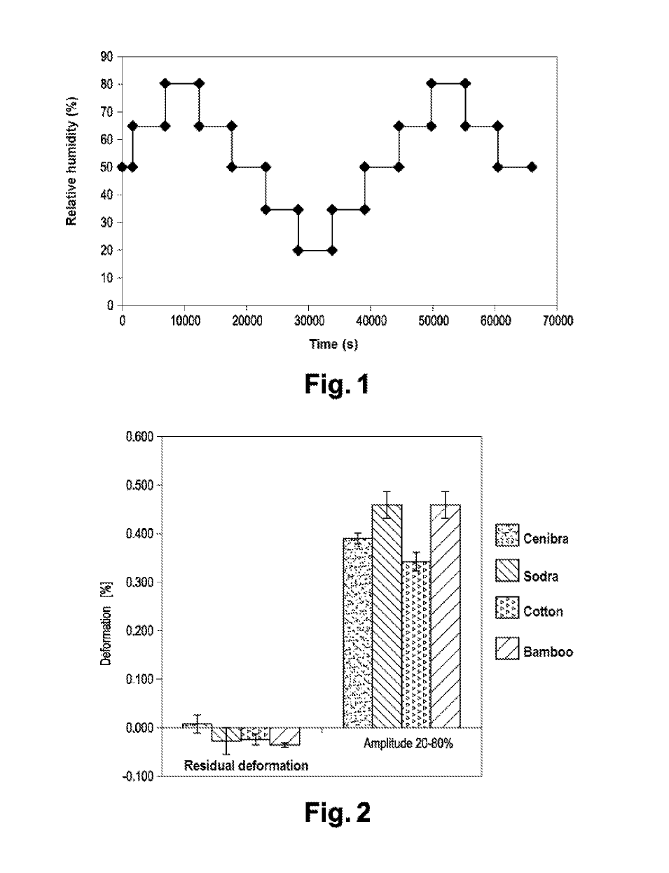

FIG. 1 is a graph representing the humidity rate as a function of time during a humidity cycle;

FIG. 2 comprises a first graph representing the residual deformation of a sheet of paper at the end of a humidity cycle, for four different types of fibres, and a second graph representing the total amplitude of the deformation of the paper during said humidity cycle for the four types of fibres;

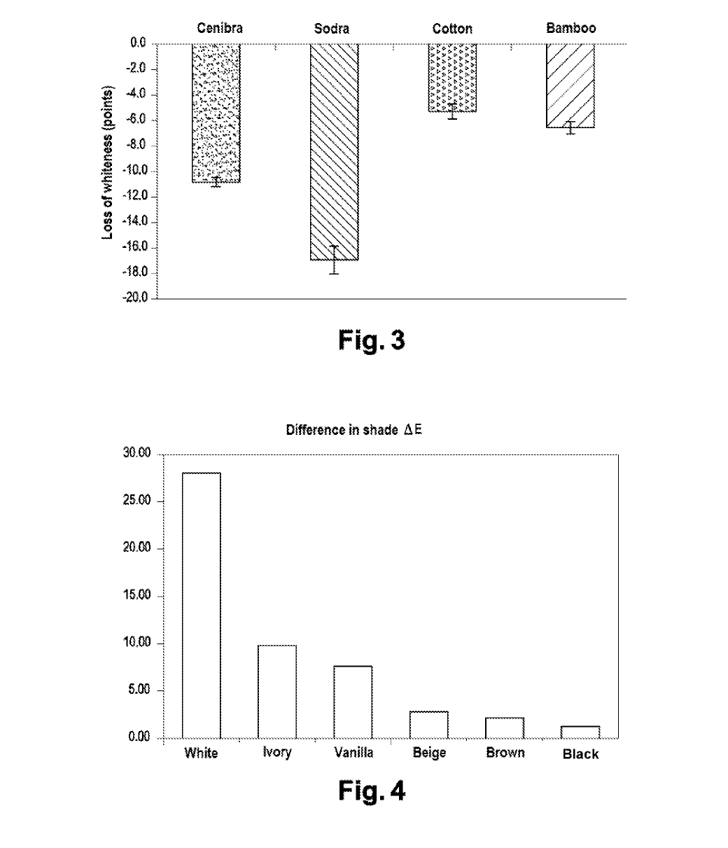

FIG. 3 is a graph illustrating the loss of whiteness or difference in shade ΔE after annealing, for four different types of fibres;

FIG. 4 is a graph illustrating, for four papers with different colours, the difference in shade ΔE obtained after annealing;

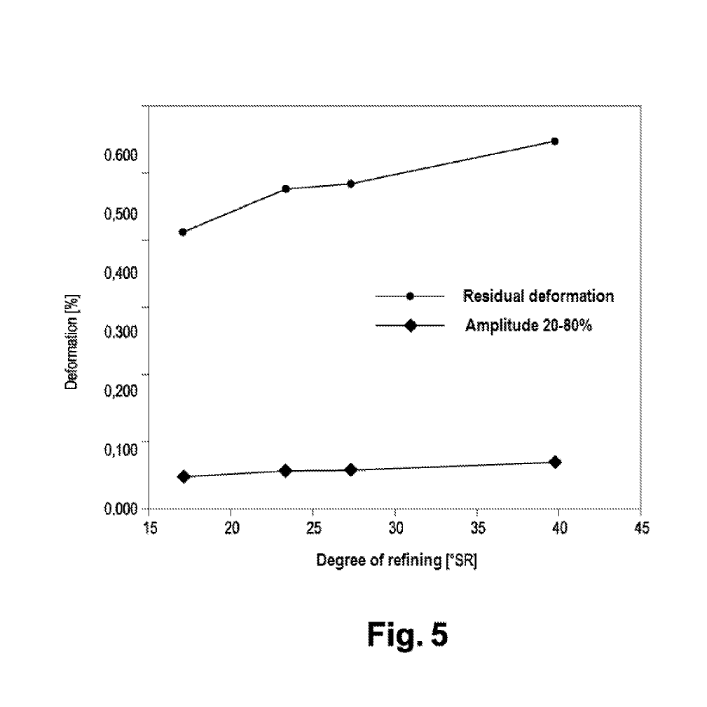

FIG. 5 is a graph illustrating, for different degrees of refining, the residual deformation and total amplitude of the deformation of paper during a humidity cycle.

### EXAMPLE 1

### Demonstrating the Influence of the Type of Binder on the Thermal Resistance of Paper, in Particular on the Yellowing of Paper

In this example, several papers each comprising a substrate comprising cellulosic wood fibres obtained from eucalyptus were produced, known under the reference Cenibra®, covered with a layer in particular comprising pigments and a binder. For these different papers, the type of binder used in the layer was varied and for each type of binder used, the residual whiteness of the coated paper obtained was measured after annealing for 5 minutes at 220° C.

The residual whiteness is the ratio of the whiteness measured after annealing with respect to the whiteness measured before annealing, expressed as a percentage. The whiteness values mentioned above were measured using ISO standard 2470.

For each binder, its commercial denomination, the type of binder, the glass transition temperature Tg of said binder and the residual whiteness measured after annealing are indicated.

The results obtained were as follows:
Binder 1: Styronal D 517; styrene-butadiene; Tg=0° C.; measured residual whiteness: 19%
Binder 2: Acronal S 305 D; butyl-acrylate and styrene; Tg=25° C.; measured residual whiteness: 55%
Binder 3: PVA BF 17 H; polyvinyl alcohol; measured residual whiteness: 45%
Binder 4: Acronal S 728; butyl-acrylate and styrene; Tg=25° C.; measured residual whiteness: 49%
Binder 5: Acronal LN 579 S; acrylic ester and acrylonitrile; Tg=7° C.; measured residual whiteness: 61%
Binder 6: Acronal S 888 S; acrylic ester, styrene and acrylonitrile; Tg=31° C.; measured residual whiteness: 47%
Binder 7: Acronal DS 2416; acrylic ester and styrene; Tg=38° C.; measured residual whiteness: 72%
Binder 8: Acronal S 996 S; acrylic ester and styrene; Tg=46° C.; measured residual whiteness: 62%
Binder 9: Esacote PULPER 21/S; aliphatic polyurethane; measured residual whiteness: 33%

It should be noted that the binders offering the best thermal resistance to yellowing, i.e. the best residual whiteness after annealing, are acrylic or acrylic ester type binders such as the binders with references 5, 7 and 8, for example.

### EXAMPLE 2

### Demonstration of the Influence of the Glass Transition Temperature, Tg, of a Binder on the Thermal Resistance of a Paper, in Particular on the Deformation of the Paper Out of the Plane of the Sheet of Paper

The amplitude of these deformations was measured by image analysis using a triangulation method with the aid of two CCD cameras, the measurements being carried out 60 minutes after annealing. A method of this type for measurement by image analysis is known from the article “Stereo image correlation for full-field measurement on composite femoral bones during compression tests”, Remi Billard et al., published on 21 Mar. 2012.

In this example, several papers each comprising a substrate comprising wood cellulose fibres obtained from eucalyptus were produced, known under the reference Cenibra®, covered with a layer comprising in particular pigments and a binder. For these various papers, the type of binder used in the layer was varied and for each type of binder used, the deformation of the sheet of paper out of the plane of the sheet was measured. More particularly, for this comparative example, a binder of the type Acronal LN 579 S (acrylic ester and acrylonitrile) was used, the glass transition temperature Tg of which was 7° C. (binder 6 in Example 1), and also a binder of the Acronal S728 (butyl-acrylate and styrene) type, the glass transition temperature Tg of which was 25° C. (binder 4 in Example 1). The paper obtained thereby underwent an annealing step at 120° C. for 10 minutes.

An out of plane deformation of 15 mm was obtained for binder 6, the glass transition temperature Tg of which was 7° C., and an out of plane deformation of 35 mm was obtained for the binder 4, the glass transition temperature Tg of which was 25° C.

It was thus observed that, the lower the glass transition temperature of the binder, the higher is the thermal resistance of the paper in terms of deformation.

### EXAMPLE 3

### Demonstration of the Influence of the Type of Fibres on the Deformation of Said Paper

In this example, several papers each comprising a fibrous substrate were produced, covered with a layer comprising in particular pigments and a binder. For these various papers, the type of fibres used in the substrate was varied and for each type of fibre used, the residual deformation of the sheet of paper thus produced after a humidity cycle as described below, as well as the total amplitude of the deformation of said sheet during such a cycle were measured. In particular, the deformation in the plane of the sheet of paper was measured.

To measure these deformations, a Varidim type instrument was used. Furthermore, during a humidity cycle, the relative humidity rate of the sheet of paper was varied with time in accordance with the rule illustrated in the graph of FIG. 1. This graph represents the relative humidity of the sheet, expressed as a percentage, with respect to time, expressed in seconds. It should be noted that during a cycle, the starting relative humidity is 50%, increasing slowly to 80% before reducing to 20%, then increasing again slowly to 80% before again being gradually reduced to 50%.

FIG. 2 comprises two diagrams, wherein a first graph represents the residual deformation of the sheet of paper at the end of a humidity cycle, for four different types of fibres, namely:
Fibres A: short cellulose wood fibres obtained from a bleached chemical pulp of eucalyptus known under the reference Cenibra®, with a mean length comprised in the range 0.5 to 1.5 mm,
Fibres B: long cellulose wood fibres obtained from softwoods known under the reference Sodra®, with a mean length comprised in the range 1.5 to 3 mm,
Fibres C: short cotton fibres with a mean length comprised in the range 0.5 to 2 mm,
Fibres D: long bamboo fibres with a mean length comprised in the range 0.8 to 1.8 mm.

The second graph represents the total amplitude of the deformation of the paper, in the plane of the sheet and during a humidity cycle, for each of the types of fibres A to D cited above.

It was observed that using short fibres (Cenibra®, cotton) allows reducing the total and residual deformations of the paper undergoing a humidity cycle compared with a substrate comprising long fibres (Sodra®, bamboo).

### EXAMPLE 4

### Demonstration of the Influence of the Type of Fibres on the Yellowing of Paper

In this example, several papers each comprising a fibrous substrate covered with a layer comprising in particular pigments and a binder were produced. For these various papers, the type of fibres used in the substrate was varied and for each type of fibres used, the differences in shade of the paper between the paper obtained after annealing relatively to the same paper before annealing was measured. The paper was white in colour before annealing.

More particularly, the annealing was carried out in an oven at a temperature of 200° C. for 5 minutes. The difference in shade, also known as the loss of whiteness, is generally denoted ΔE and is calculated from the CIE LAB coordinates for paper using the following formula: ΔE=(L²+A²+B²)^{0.5}, as is well known per se.

FIG. 3 is a graph illustrating the loss of whiteness or difference in shade ΔE for four different types of fibres, namely:
Fibres A: short cellulose wood fibres obtained from a bleached chemical pulp of eucalyptus, known under the reference Cenibra®, with a mean length comprised in the range 0.5 to 1.5 mm,
Fibres B: long cellulose wood fibres obtained from softwoods, known under the reference Sodra®, with a mean length comprised in the range 1.5 to 3 mm,
Fibres C: short cotton fibres with a mean length comprised in the range 0.5 to 2 mm,
Fibres D: long bamboo fibres with a mean length comprised in the range 0.8 to 1.8 mm.

It was observed that this difference in shade is all the more reduced as the lignin content of the fibres is lower. In particular, this difference in shade is relatively small for cotton fibres, for bamboo fibres and for wood fibres obtained from eucalyptus (Cenibra®). In contrast, this difference in shade is relatively large for wood fibres obtained from softwoods (Sodra®).

### EXAMPLE 5

### Demonstration of the Influence of the Colour of the Substrate Before Annealing on the Yellowing of the Paper after Annealing

In this example, different papers each comprising a fibrous substrate covered with a layer comprising in particular pigments and a binder were produced. For these various papers, the colour of the substrate (and thus of the paper) was varied by adding a colorant to the pulp, for example in the pulper, during the production of the paper. In particular, this example comprised six papers with different shades, before annealing, respectively white, ivory, vanilla, beige, brown and black papers. The above colours are listed in the reverse order of their whiteness.

These various papers then underwent an annealing step at 220° C. for 5 minutes.

FIG. 4 is a graph illustrating, for each paper, the difference in shade ΔE obtained after annealing, by comparison with the same paper before annealing. It will be seen that the difference in shade is very large for a paper with a starting colour (i.e. before annealing) which is the colour white and that this difference in shade is almost zero for a paper with a starting colour which is the colour black, the difference in shade varying progressively from one extreme to the other as a function of the starting colour of the paper.

### EXAMPLE 6

### Demonstration of the Influence of Degree of Refining (Measured in Degrees Schopper-Riegler or ° SR) of the Fibrous Pulp on the Deformation of Said Paper

In this example, several papers each comprising a fibrous substrate covered with a layer comprising in particular pigments and a binder were produced. In particular, the substrate had a filler content of 15%.

For these various papers, the degree of refining (measured in degrees Schopper-Riegler, denoted ° SR) of the fibrous pulp was varied and for each paper, the residual deformation of the sheet of paper thus obtained was measured after a humidity cycle identical to that described above with reference to FIG. 1. The total amplitude of the deformation of the sheet during a cycle was also measured. These deformations correspond to the deformations of the sheet of paper in its plane. As described above, to measure these deformations, a Varidim type instrument was used.

FIG. 5 is a graph illustrating, for each paper, and thus for different degrees of refining, said residual deformation (curve C1) and said total amplitude of the deformation (curve C2). It can be seen that these deformations are all the more low as the degree of refining is lower.

Similarly, the influence of the degree of refining on the deformation of the sheet of paper out of its plane was studied.

To this end, two papers were prepared, one produced from a fibrous pulp with a degree of refining of 40° SR and one produced from a fibrous pulp with a degree of refining of 35° SR. The deformations were measured using the triangulation image analysis method described above.

It was observed that the out of plane deformation for the paper prepared from a pulp with a degree of refining of 40° SR was 4.8 mm, while it was only 3.2 mm for the paper prepared from a pulp with a degree of refining of 35° SR.

As a consequence, it has been established that deformations of this type are all the more low as the degree of refining of the pulp is smaller.

### EXAMPLE 7

### Example of a Paper in Accordance with One Embodiment of the Invention

In this embodiment, a homogeneous fibrous pulp was prepared in a pulper. The pulp comprised water, a yellow colorant (with a negligible dry weight content) in order to obtain a cream shade for the substrate, approximately 80% in dry weight of wood cellulose fibres obtained from eucalyptus of the Cenibra® type and approximately 20% in dry weight of calcium carbonate (CaCO3) known by the reference Omyacarb®.

The pulp then passed through a refiner where its degree of refining was adjusted to approximately 35° SR.

The composition of the pulp was then adjusted in the head box of a paper machine by adding a Hi-cat 1134A type cationic starch, in a proportion of 1% by weight with respect to the dry matter content in the pulp.

As indicated above, the head box allowed the pulp to be distributed uniformly over a wire where a sheet was formed before passing through the press section then the dryer of the paper machine.

The sheet then underwent a surface coating treatment by passage through a size press in order to form at least one layer. During this step, the sheet passed through a bath the composition of which is summarized in the following table:

| Product used | Reference | Parts in dry weight |
|---|---|---|
| Water | | 0 |
| Kaolin type pigment | Capim ® RG | 70 |
| CaCO₃ type pigment | Carbital ® 95 | 30 |
| Total pigment | | 100 |
| Anti-foaming agent | Nopcomaster ® MPE 847 | 0.1 |
| Cross-linking agent | Cartabond ® MZI | 0.5 |
| Sodium hydroxide | | 1 |
| Latex | Acronal ® LN579S | 19 |
| PVA | Mowiol ® 4-98 | 8 |

The sheet then passed into the section termed the calendering section.

At the end of these various steps, the sheet was in the form of a continuous web comprising an inner zone or core forming a substrate or a fibrous mat, the composition of which was defined by the fibrous pulp, and at least one outer surface of which was covered with a layer, the composition of which was defined by the bath of the size press.

This sheet of paper may optionally undergo finishing operations.

A paper of this type has a relatively low surface porosity, a very low yellowing in the case of annealing (a ΔE of less than 3 for an annealing of 5 minutes at 180° C.), a very low dimensional shrinkage (less than 0.25% for an annealing of 5 minutes at 180° C.) and allows obtaining a high thermal conductivity for the printed electroconductive tracks.

By way of example, the table below presents comparative examples between such a paper in accordance with the invention and other commercially available papers, respectively a paper suitable for printing photographs (hereinafter termed photographic paper), a coated paper sold by Arjowiggins Creative Paper with the reference Sensation®, and a glossy coated paper sold by Arjowiggins Creative Paper with the reference Main Gloss® These comparative examples show the different values for the differences in shade ΔE for different temperatures and for different annealing durations. The values for said shade differences ΔE are indicated in the table below.

| | Paper | Photo- | | Main |
|---|---|---|---|---|
| | according to | graphic | Sensation ® | Gloss ® |
| | Example 7 | paper | Paper | Paper |
| 200° C./5 min | ΔE = 2.2 | ΔE = 25.9 | ΔE = 8.5 | ΔE = 17.3 |
| 180° C./5 min | ΔE = 0.6 | ΔE = 10.1 | ΔE = 5.7 | ΔE = 8.8 |
| 150° C./5 min | ΔE = 0.2 | / | ΔE = 2.6 | ΔE = 3.1 |
| 150° C./1.5 min | ΔE = 0.2 | ΔE = 1.0 | ΔE = 1.7 | ΔE = 1.4 |

It will thus be observed that in the case of the paper of the invention in accordance with Example 7 described above, the difference in shade obtained after annealing was very small by comparison with the other papers.

The table below presents other comparative examples comparing the paper in accordance with the invention, in accordance with Example 7, and the Sensation® and Main Gloss® papers mentioned above. In these comparative examples, the resistance R of the conductive tracks printed by screen printing or by flexography, having then undergone an annealing treatment, was measured for each of the papers mentioned above. The values for said resistances are indicated in the table below.

| | | Paper | | Main |
|---|---|---|---|---|
| Type of | Type of | according to | Sensation ® | Gloss ® |
| printing | annealing | Example 7 | Paper | Paper |
| Screen | 150° C./5 min | R = 39 Ω/sq | R = 45 Ω/sq | R = 53 Ω/sq |
| printing | | | | |
| Dupont | | | | |
| 5064 | | | | |
| silver ink | | | | |
| Flexo- | 180° C./5 min | R = 1700 Ω/sq | | |
| graphy | | | | |
| Agfa | | | | |
| silver ink | | | | |
| Flexo- | 150° C./90 s | | more than | more than |
| graphy | | | 90 000 Ω/sq | 90 000 Ω/sq |
| Agfa | | | | |
| silver ink | | | | |

It can thus be seen that using paper in accordance with Example 7 of the invention allows reducing the resistance of the printed conductive tracks, and thus improving their electrical conductivity, by comparison with other commercially available papers.

### EXAMPLE 8

### Demonstration of the Influence of the Process for Depositing the Pigment Layer onto the Substrate on the Surface State of the Support, and as a Consequence on the Adhesion of the Electroconductive Ink

A support (powercoat HD 230) obtained by the process described in patent application WO 2013/104520 cited in the introduction to the present document was compared with the support of the present invention.

Firstly, a Scotch 3M paper tape test for the adhesion of ink was carried out. The following were used:
a Scotch 3M 2525 paper tape, used in the known tear test for paints and varnishes,
an Agfa Orgacon SI-P1000x ink, printed using screen printing,
three different supports.

By means of the support of patent application WO 2013/104520 as printed in this manner, a portion of the ink was torn off using the Scotch paper tape. With the support of the present invention, no particles of ink were found on the Scotch paper tape. Starting from a PET film, few particles of ink remained attached to the Scotch paper tape.

Secondly, an adhesion test was carried out during a photonic annealing. A Novacentrix ICI-021 copper ink was used on a DEK horizon 03i press, and open air drying was carried out, followed by a photonic annealing using light pulsed with a Xenon Sinteron 2000.

With the support of patent application WO 2013/104520, poor adhesion of the copper during the annealing was observed. It was impossible to find satisfactory parameters. Using the support of the present invention, good adhesion of the copper was observed. On the PET support, copper adhesion was poor and the temperature for the reduction of copper (approximately 500° C.) ran the risk of deformation of the PET.

These differences can be explained by the variation in microporosity of the pigment layer at the surface of the support between the patent application WO 2013/104520 and the present invention. Indeed, using a plastic film to deposit the pigment layer at the surface of the support as described in patent application WO 2013/104520, induces a very high surface smoothness of the support, along with a near-absence of microporosity. In contrast, using a coating within the meaning of the present invention induces a sufficient microporosity to allow inks to adhere to the pigment layer.

In order to characterize the microporosity of the support surface, a Microcontour® test was carried out:

The Microcontour test was carried out in order to evaluate, in a simple manner, the surface state of samples by application of a blue Microcontour Test® ink, Lorilleux (ref 3811). After covering the two supports mentioned above (in accordance with WO 2013/104520 and in accordance with the invention) using an inked roll, the two surfaces were wiped. This step allows visual detection of irregularities on the surface or coating defects. After drying, optical density measurements were carried out at a wavelength in the visible (380-780 nm) in order to quantify the ink remaining on the support.

This is a simple way of providing an idea of the roughness and/or porosity of a support. In fact, the special ink contains pigments which are fairly coarse in size which can only become attached to very rough and/or porous surfaces.

| | WO 2013/ | Support of |
|---|---|---|
| Optical density | 104520 support | the invention |
| Mean | 0.04 | 0.61 |
| Standard deviation | 0.01 | 0.061 |
| Coefft of variation | 25.0 | 10.0 |

The results of this test confirm the apparent differences for the support in accordance with patent application WO 2013/104520 and the support of the invention: the values for the optical densities between the two supports are very different: the smooth closed paper of application WO 2013/104520 has a very low optical density because the ink has not resisted being wiped. In contrast, the support of the invention has an optical density which is normal, because the ink has immediately penetrated the surface due to the microporosity.

1. A paper comprising a fibrous substrate comprising at least one side covered with at least one layer, said layer comprising:
100 parts in dry weight of pigments,
5 to 50 parts in dry weight of one or more binders which are resistant to an exposure to temperatures comprised in a range 140° C. to 200° C. and having a glass transition temperature of less than or equal to 20° C.,
0 to 15 parts in dry weight of a viscosifying agent.

2. The paper as claimed in claim 1, wherein said layer comprises 10 to 30 parts in dry weight of acrylic binder with a glass transition temperature of 20° C. or less.

3. The paper as claimed in claim 1, wherein said layer comprises 5 to 10 parts in dry weight of polyvinyl alcohol.

4. The paper as claimed in claim 1, wherein the fibrous substrate comprises 70% to 90% in dry weight of short cellulose fibres with a mean length in a range 0.5 to 1.5 mm.

5. The paper as claimed in claim 4, wherein the substrate comprises 80% in dry weight of short cellulose fibres.

6. The paper as claimed in claim 1, wherein the fibrous substrate comprises 10% to 30% by weight of at least one mineral filler.

7. The paper as claimed in claim 1, wherein the paper has a whiteness comprised in a range of 70 to 90.

8. The paper as claimed in claim 1, wherein the difference in shade, ΔE, of the paper, calculated from the CIE LAB coordinates of the paper, after an annealing at 200° C. for 5 minutes is less than 5, compared with said paper before annealing.

9. The paper as claimed in claim 1, wherein the layer covering at least one side is printed over all or a portion of the surface of said layer with a layer of electroconductive ink having a thickness in a range of 0.5 to 15 μm.

10. A process for the production of a paper wherein the process comprises:
forming a fibrous substrate with the aid of a fibrous pulp,
at least partially covering at least one surface of the fibrous substrate by coating with a layer comprising 100 parts in dry weight of pigments, 5 to 50 parts in dry weight of one or more binders which are resistant to an exposure and to temperatures comprised in a range of 140° C. to 200° C. and having a glass transition temperature of less than or equal to 20° C., and 0 to 15 parts in dry weight of a viscosifying agent,
so as to obtain the paper as claimed in claim 1.

11. The process as claimed in claim 10, wherein the degree of refining of the fibrous pulp is less than 50° SR.

12. The process as claimed in claim 10, wherein said layer is applied by coating with the aid of a size press of a paper machine.

13. A process for the production of an electroconductive product, comprising the steps consisting of:
covering, by printing using an electroconductive ink, at least one zone of a support produced from a paper as claimed in claim 1,
annealing the support and the ink so as to form an electroconductive layer or continuous track on the support.

14. The process as claimed in claim 13, wherein the annealing temperature is comprised in a range of 100° C. to 300° C.

15. The process as claimed in claim 13, wherein the layer of ink deposited by printing on the support is comprised in a range of 0.5 to 15 μm.

16. The process as claimed in claim 13, wherein the electroconductive ink is deposited using a screen printing, flexographic or heliographic type printing process.

17. A paper comprising a fibrous substrate comprising a side covered with a layer onto which an electroconductive ink is printed, wherein the paper is obtained by:
forming a fibrous substrate with the aid of a fibrous pulp,
at least partially covering at least one surface of the fibrous substrate by coating with a layer comprising 100 parts in dry weight of pigments, 5 to 50 parts in dry weight of one or more binders which are resistant to an exposure and to temperatures comprised in a range of 140° C. to 200° C. and having a glass transition temperature of less than or equal to 20° C., and from 0 to 15 parts in dry weight of a viscosifying agent;
covering at least one zone of the layer by printing using an electroconductive ink;
annealing the coated substrate and the ink so as to form an electroconductive layer or continuous track on the support.

18. The paper as claimed in claim 1, wherein the one or more binders comprise one or more acrylic binders, the glass transition temperature of which is less than or equal to 20° C.

19. The paper as claimed in claim 1, wherein the one or more bindershave a glass transition temperature of less than or equal to 10° C.

20. The paper as claimed in claim 1, wherein the viscosifying agent comprises polyvinyl alcohol.
